(19) United States
(12) Patent Application Publication
(10) Pub. No.: US 2018/0012117 A1
(43) Pub. Date: Jan. 11, 2018

(54) MEDICATION CONTAINERS INCORPORATING WIRELESS COMMUNICATION DEVICES AND METHODS FOR MANUFACTURING SUCH CONTAINERS

(71) Applicant: AVERY DENNISON RETAIL INFORMATION SERVICES, LLC, MENTOR, OH (US)

(72) Inventor: IAN J. FORSTER, CHELMSFORD-ESSEX (GB)

(21) Appl. No.: 15/204,503

(22) Filed: Jul. 7, 2016

(51) Int. Cl. G06K 19/077; B65B 47/02; B65B 61/20; B65B 5/04; B65B 5/02; A61J 1/03; B65B 7/28

(52) U.S. Cl. CPC G06K 19/07798; G06K 19/0776; G06K 19/07728; G06K 19/07726; G06K 19/07722; A61J 1/035; B65B 47/02; B65B 7/28; B65B 5/04; B65B 5/02; B65B 61/20

(57) ABSTRACT

Medication containers are provided with a body having a wireless communication device secured to a lower surface of the body. The wireless communication device includes an RFID chip and a slot-loop hybrid antenna electrically coupled to the RFID chip. The antenna includes a conductor sheet defining a slot and an aperture. The body defines a downwardly extending cell that is configured to receive a medication, with the aperture of the conductor sheet receiving at least a portion of the cell. The conductor sheet may include a plurality of apertures and the body may define a plurality of cells, with each aperture receiving a different one of the cells. A cover may be secured to an upper surface of the body to enclose the medication within the cell. If the medication container includes a plurality of cells and a frangible cover, it may be configured as a blister pack.

### BACKGROUND

### Field of the Disclosure

The present subject matter relates to medication containers. More particularly, the present subject matter relates to systems for remotely tracking and/or identifying medication containers involving radio frequency identification (“RFID”) technology and methods for incorporating RFID technology into a medication container.

### Description of Related Art

It is known to employ RFID technology to remotely track and identify items within an RFID read field. In one example, an RFID reader is associated with a point-of-sale location or check-out counter of a store and detects a tag associated with an item being purchased to register the price of the item. In another example, an RFID-readable tag or transponder is attached to each piece of merchandise in a store or storage area. The tags are scanned using an RFID reader to keep proper count of the product inventory. In yet another example, RFID technology is used as a security measure.

RFID devices incorporated into a merchandise tag may have a variety of integrated components, among them an RFID chip containing data such as an identification code for the type of product and even for the exact piece of goods associated with a unique identification code. Other components may include an antenna electrically connected to the RFID chip, which is responsible for transmitting signals to and/or receiving signals from another RFID device, for example, an RFID reader system. The antenna may take any of a number of forms including, in some circumstances, a hybrid loop-slot antenna or slot-loop hybrid antenna, which is commonly referred to as a “sloop” antenna. Configurations of these types of hybrid or sloop antennas are shown in U.S. Pat. No. 7,298,343 and U.S. Pat. No. 8,072,334, both of which are incorporated herein by reference in their entirety.

One type of merchandise that may be desirable to remotely track and/or identify is a medication container. In some circumstances, it may be sufficient to attach a typical RFID device (e.g., an RFID label with an adhesive surface) to a medication container. However, in other circumstances, a typical RFID device will not provide sufficient functionality (e.g., not being readable in a sufficiently large read field) and/or fail to be sufficiently robust to withstand the stresses placed upon the medication container by a user (e.g., when breaking a portion of the container to access a dose of medication). Accordingly, it would be advantageous to provide a medication container having enhanced functionality and durability, without significantly increasing the size and/or cost of the container and without significantly changing the way in which the container is used by a medical patient.

### SUMMARY

There are several aspects of the present subject matter, which may be embodied separately or together in the devices and systems described and claimed below. These aspects may be employed alone or in combination with other aspects of the subject matter described herein, and the description of these aspects together is not intended to preclude the use of these aspects separately or the claiming of such aspects separately or in different combinations as may be set forth in the claims appended hereto.

In one aspect, a wireless communication device is provided for use in combination with a medication container defining at least one medication-containing cell. The wireless communication device includes an RFID chip and a slot-loop hybrid antenna electrically coupled to the RFID chip. The antenna includes a conductor sheet defining a slot and at least one aperture, with the aperture of the conductor sheet being configured to receive at least a portion of the cell.

In another aspect, a medication container is provided with a body including an upper surface and a lower surface. The body defines at least one downwardly extending cell configured to receive a medication. The medication container further includes a wireless communication device secured to the lower surface of the body. The wireless communication device includes an RFID chip and a slot-loop hybrid antenna electrically coupled to the RFID chip. The antenna includes a conductor sheet defining a slot and at least one aperture, with the aperture of the conductor sheet receiving at least a portion of the cell.

In yet another aspect, a method is provided for manufacturing a medication container. The method involves providing a conductive material defining a slot and at least one aperture. An RFID chip is electrically coupled to the conductive material, thereby forming a wireless communication device. A thermoformable material including upper and lower surfaces is provided, with the conductive material being secured to the lower surface of the thermoformable material. At least one cell is formed in the thermoformable material so as to cause at least a portion of the cell to be received by the aperture of the conductive material.

### BRIEF DESCRIPTION OF THE DRAWINGS

FIG. 1 is a plan view of a wireless communication device according to an aspect of the present disclosure, which is configured to be secured to a medication container;

FIG. 2 is a side cross-sectional view of a cell of a medication container having the wireless communication device of FIG. 1 secured to a body of the medication container;

FIG. 3 is a top plan view of a medication container incorporating the wireless communication device of FIG. 1; and

FIG. 4, FIG. 5, FIG. 6 and FIG. 7 are respective side cross-sectional views of a region of a medication container according to the present disclosure, with a cell being formed in said region and then filled with a medication and covered.

### DESCRIPTION OF THE ILLUSTRATED EMBODIMENTS

As required, detailed embodiments of the present invention are disclosed herein; however, it is to be understood that the disclosed embodiments are merely exemplary of the invention, which may be embodied in various forms. Therefore, specific details disclosed herein are not to be interpreted as limiting, but merely as a basis for the claims and as a representative basis for teaching one skilled in the art to variously employ the present invention in virtually any appropriate manner.

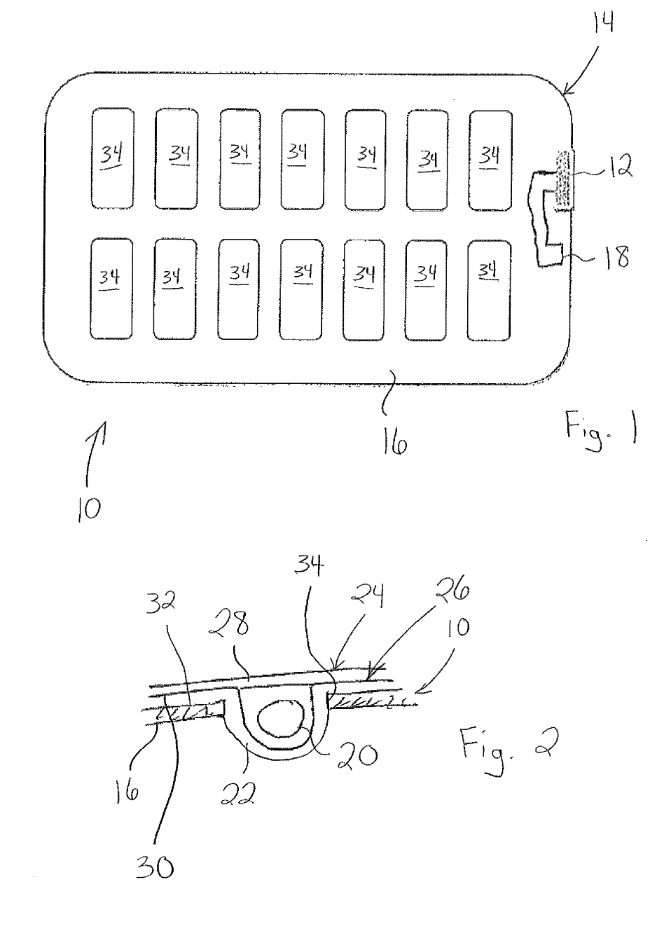

FIG. 1 illustrates a wireless communication device, generally designated at 10, that may be combined with a medication container, according to an aspect of the present disclosure. The wireless communication device 10 includes an RFID chip 12, with an antenna, generally designated at 14, electrically coupled to the RFID chip 12. In the illustrated embodiment, the illustrated antenna 14 is of the hybrid loop-slot or “sloop” antenna type. The antenna 14 includes a conductive material that is preferably provided as a substantially flat or planar conductor sheet 16 (e.g., a conductive foil). In the illustrated embodiment, the perimeter of the conductor sheet 16 is generally rectangular with rounded corners, which perimeter may be configured to substantially coincide with the perimeter of a medication container to which the wireless communication device 10 is to be secured. In other embodiments, the perimeter of the conductor sheet 16 may be differently configured to match the perimeter of a differently shaped medication container or the conductor sheet 16 may be shaped differently from the associated medication container.

A slot 18 is defined in the conductor sheet 16, with the slot 18 (along with the RFID chip 12) being an “active” component of the wireless communication device 10. The slot 18 may extend between a closed end and an open end, with the open end being associated with one of the edges or ends of the conductor sheet 16. In the illustrated embodiment, the slot 18 is associated with one of the shorter edges or ends of the generally rectangular perimeter of the illustrated conductor sheet 16, but the slot 18 may be differently positioned and/or oriented without departing from the scope of the present disclosure. Additionally, the shape of the slot 18 may vary without departing from the scope of the present disclosure.

As for the RFID chip 12, it may take any of a number of forms (including form types commonly referred to as a “chip” or a “strap” by one of ordinary skill in the art), include any of a number of possible components, and be configured and programmed to perform any of a number of possible functions. For example, in one embodiment, the RFID chip 12 includes an integrated circuit for controlling radio frequency (RF) communication and other functions of the wireless communication device 10. In the illustrated embodiment, two ends or points of the RFID chip 12 are connected to the conductor sheet 16 at opposite sides of the slot 18, which serves to electrically couple the RFID chip 12 to the conductor sheet 16. In the embodiment shown in FIG. 1, the RFID chip 12 is positioned directly adjacent to the open end of the slot 18 and the end or edge of the conductor sheet 16, with the RFID chip 12 being oriented substantially parallel to the adjacent end or edge of the conductor sheet 16. In other embodiments, the RFID chip 12 may be differently configured and oriented, although the illustrated orientation may be advantageous in that it spaces the RFID chip 12 away from the medication housed within an associated medication container, thereby decreasing the risk that the RFID chip 12 will be contacted and damaged by a patient attempting to access the medication.

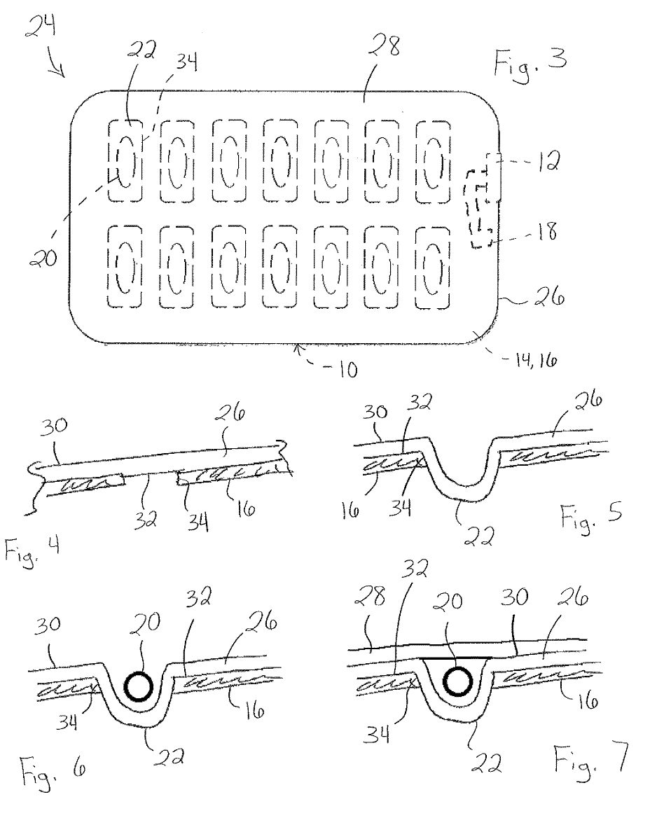

In the illustrated embodiment, medication 20 is contained within individual chambers or cells 22 of the medication container 24 (FIGS. 2 and 3). FIG. 2 only shows one cell 22 of the medication container 24, but it should be understood that the medication container 24 includes at least one cell 22, but more preferably includes a plurality of cells 22, as in FIG. 3. If the medication container 24 is provided with a plurality of cells 22, it may be advantageous for the cells 22 to be substantially identical (as in FIG. 3), but it is also within the scope of the present disclosure for a medication container to include only one cell or to include a plurality of cells differently configured with respect to volume, depth, perimeter size, perimeter shape, color, texture, for example, and combinations thereof.

In the illustrated embodiment, the cells 22 are downwardly extending pockets or cavities or indentations formed in the body 26 of the medication container 24. The body 26 may be formed of any of a number of materials, such as polymeric sheeting or cellulosic sheeting or combinations of sheeting materials that can be formed efficiently while providing adequate protection to the contents of each cell 22. In one embodiment, the body 26 is formed of a plastic material or another material that is substantially non-conductive. It may be advantageous for the body 26 to be formed of a material that is generally rigid, but sufficiently deformable that a human may deform the individual cells 22 using a finger or digital force and manipulation. In a preferred embodiment, the body 26 is configured to provide for a medical container 24 taking the general form of a blister pack, with the body 26 being a thin plastic sheet that is provided with a plurality of cells 22, each containing one or more medications 20, which may be individually accessed and ingested.

As in the illustrated embodiment, it may be thought to be advantageous or efficient for a medication container 24 having a plurality of cells 22 to be provided from a single sheet or body 26 that is formed to define all of the cells 22. It is also within the scope of the present disclosure for the cells 22 of a single medication container 24 to be separately or non-integrally formed, such that less than all of a plurality of the cells 22 are formed from a formable sheet or body 26. This can result in formation of multiple groups or modules having a plurality of cells grouped in a row or otherwise in general alignment with each other. Each group or module can then be assembled into a medication container of desired size and configuration. Other embodiments may have individual cells formed as separate modules.

Each cell 22 may be formed according to any suitable approach or method, which may depend on any of a number of factors. In one embodiment, the body 26 of the medical container 24 is formed of a thermoformable material, which allows for the cells 22 to be formed by vacuum forming or by pressing a heated tool into a substantially planar sheet of material. If the body 26 is to define a plurality of cells 22, the cells 22 may be formed either individually or simultaneously. As will be described in greater detail, the cells 22 may be formed before or after the wireless communication device 10 is secured to the body 26 of the medication container 24.

A cover is secured to an upper surface 30 of the body of the container

24, with each cell 22 being closed or overlaid by the cover 28. A cell 22 may be accessed through the cover 28 to remove medication 20 from that cell 22. In one embodiment, the cover 28 is a thin sheet of material, such as a metallic foil, which may be broken to allow medication 20 to pass out of the cell 22. If the cover 28 is formed of a conductive material, it may be advantageous for the body 26 of the medication container 24 to be formed of a non-conductive material (e.g., plastic) to prevent contact between the cover 28 and the conductor sheet 16 of the wireless communication device 10 (which could affect the functionality of the antenna 14). When the antenna is primarily a continuous sheet of conductor and the apertures are provided in the antenna, which is designed to fit over the chamber(s) or cell(s), the material of the antenna does not significantly change the ejection or removal properties of the front surface. In addition, a typical cell has a thickness adequate to space or separate the RFID device from the foil so the antenna can operate especially effectively in proximity to the metal base. If the cover 28 is formed of a frangible material, a base or bottom surface of the cell 22 may be pressed toward the frangible cover 28 by a user, urging the medication 20 against the underside of the cover 28 until the force on the cover 28 exceeds the strength of the cover 28, at which point the cover 28 breaks and the medication 20 may be removed from the cell 22. Alternatively, the cell 22 may remain untouched, while the cover 28 is directly engaged and broken by digital force or with simple tool assist in order to remove medication 20 from the cell 22. If the medication container 24 is provided with a plurality of cells 22, it may be preferred for a single cover 28 to overlay all of the cells 22 (as in the illustrated embodiment), but it is also within the scope of the present disclosure for two or more cells of the same medication container to be provided with a common cover, while two or more other cells are provided with a different or separate covers. In another embodiment, different cells are each overlaid by a separate, non-frangible (e.g. hinged) cover. FIGS. 2 and 3 show a fully assembled medication container 24, with the wireless communication device 10 being secured to a lower surface 32 of the body 26 of the medication container 24. Preferably, the conductor sheet 16 is relatively large to improve the performance of the sloop antenna 14. For example, as in the embodiment of FIG. 3, the conductor sheet 16 may have a height and width that are substantially the same as the height and width of the body 26 of the associated medication container 24. In other embodiments, the conductor sheet may be smaller or larger than the body of an associated medication container.

In order to allow the wireless communication device 10 (especially one having a large conductor sheet 16) to be secured to the lower surface 32 of the body 26 without covering the cells 22 (which could make it more difficult for a patient to access medication 20 within the cells 22), one or more holes or openings or apertures 34 may be defined in the conductor sheet 16. An aperture 34 may be formed in the conductor sheet 16 by any of a variety of suitable approaches, such as by a cutting procedure. The aperture 34 may be formed using the same method used to form the slot 18 of the conductor sheet 16 or a different method, with the slot 18 and aperture 34 being formed either simultaneously (using the same or different methods) or at different times.

FIG. 2 illustrates a portion of a fully assembled medication container 24 according to the present disclosure, in which a medication-containing cell 22 of the body 26 of the medication container 24 is at least partially received within an aperture 34 of the conductor sheet 16. By such a configuration, the conductor sheet 16 may be directly secured to the lower surface 32 of the body 26 of the medication container 24 without covering or otherwise interfering with any cell 22. FIG. 2 illustrates only one cell 22 and aperture 34, but it should be understood that a plurality of apertures 34 may be defined in the conductor sheet 16, as shown in FIG. 1. The apertures 34 of FIG. 1 are illustrated as being substantially identical and generally rectangular, with rounded corners, which may mirror the shape or profile of the associated medication-containing cells 22 (FIG. 3), but it is also within the scope of the present disclosure for the apertures 34 to be differently sized and configured.

In the illustrated embodiment, an equal number of apertures 34 and cells 22 are provided, with each aperture 34 being paired with a different one of the cells 22, but it is within the scope of the present disclosure for there to be a different number of cells 22 and apertures 34. For example, it is within the scope of the present disclosure for there to be fewer apertures 34 than cells 22, in which case one or more of the apertures 34 may be relatively large and configured to receive two or more cells 22. However, it may be advantageous for the number of apertures 34 and cells 22 to be the same to decrease the total percentage of the conductor sheet 16 defined by the apertures 34, thereby improving the functionality and durability of the conductor sheet 16.

The combined medication container 24 and wireless communication device 10 may be assembled or manufactured according to any of a variety of possible approaches. According to a first approach, the cells 22 may be formed in the body 26 of the medication container 24 prior to the wireless communication device 10 being secured to the lower surface 32 of the body 26. By this approach, a fully assembled and filled medication container 24 may be provided, with the wireless communication device 10 being secured to the lower surface 32 of the body 26. Alternatively, the lower surface of the body 26 of an unfilled medication container 24 may be secured to the wireless communication device 10, with the pre-formed cells 22 of the medication container 24 thereafter being filled with medication 20 and then sealed with a cover 28.

According to another approach, which is illustrated in FIGS. 4, 5, 6 and 7, the wireless communication device 10 is secured to the lower surface 32 of the body 26 of the medication container 24 prior to the cells 22 being formed and filled (e.g., while the body 26 is still substantially planar). FIG. 4 shows a region of the body 26 in which a cell 22 is to be formed. FIG. 4 represents a point in the manufacturing process at which time the wireless communication device 10 has been secured to the body 26 by any suitable means, such as the application of an adhesive therebetween or the formation of a laminate including the conductor sheet 16 and the body 26. As shown in the illustrative embodiment of FIG. 4, an aperture 34 has already been formed in the conductor sheet 16 at the time it is secured to the lower surface 32 of the body 26. In one embodiment, the wireless communication device 10 is fully formed and assembled at the time that it is secured to the body 26, but it is also within the scope of the present disclosure for the wireless communication device 10 to be only partially formed when being secured to the body 26.

With the body 26 and wireless communication device 10 secured together, the cells 22 may be formed in the body 26 (an embodiment in this regard being generally illustrated in FIG. 5), either individually or simultaneously. As described above, the cells 22 may be formed by any suitable approach, which may include vacuum forming or by pressing a heated tool into the body 26. The cells 22 are formed in a way that causes them to project downwardly through the associated aperture 34 of the conductor sheet 16.

When the cells 22 have been formed, medication 20 may be inserted into each cell 22 (an embodiment in this regard being generally illustrated in FIG. 6). Finally, the cover 28 may be secured to the upper surface 30 of the body 26 (e.g., using an adhesive or the like) to enclose the medication 20 within the cells 22 (an embodiment in this regard being generally illustrated in FIG. 7). Additional manufacturing and/or assembly steps (e.g., inserting the finished product into a box or container for sale and/or shipment) may also be employed without departing from the scope of the present disclosure.

Regardless of how the finished product is configured or manufactured, the antenna 14 of the wireless communication device 10 communicates with an RFID reader and may provide a variety of information about the medication container 24. For example, the RFID chip 12 may be programmed with information about the contents of the medication container 24 or data indicative of the identity of the medication container 24, which allows an RFID reader to track the medication container 24 as part of an inventory management system or the like. The RFID chip 12 may be programmed with any other information and/or functionality without departing from the scope of the present disclosure.

It will be understood that the embodiments described above are illustrative of some of the applications of the principles of the present subject matter. Numerous modifications may be made by those skilled in the art without departing from the spirit and scope of the claimed subject matter, including those combinations of features that are individually disclosed or claimed herein. For these reasons, the scope hereof is not limited to the above description but is as set forth in the following claims, and it is understood that claims may be directed to the features hereof, including as combinations of features that are individually disclosed or claimed herein.

1. A wireless communication device for use in combination with a medication container defining at least one medication-containing cell, the wireless communication device comprising:
an RFID chip, and
a slot-loop hybrid antenna electrically coupled to the RFID chip and including a conductor sheet defining a slot and at least one aperture, wherein the at least one aperture of the conductor sheet is configured to receive at least a portion of said at least one cell.

2. The wireless communication device of claim 1, further comprising a plurality of apertures are defined in the conductor sheet, wherein aperture is configured to receive at least a portion of a different medication-containing cell.

3. The wireless communication device of claim 2, wherein the apertures are substantially identical.

4. The wireless communication device of claim 1, wherein the conductor sheet includes a perimeter configured to substantially coincide with a perimeter of the medication container.

5. A medication container, comprising:
a body including an upper surface and a lower surface and defining at least one downwardly extending cell configured to receive a medication; and
a wireless communication device secured to the lower surface of the body and including
an RFID chip, and
a slot-loop hybrid antenna electrically coupled to the RFID chip and including a conductor sheet defining a slot and at least one aperture, wherein the at least one aperture of the conductor sheet receives at least a portion of said at least one cell.

6. The medication container of claim 5, further comprising
a plurality of downwardly extending cells defined by the body, and
a plurality of apertures defined in the conductor sheet, wherein each aperture is configured to receive at least a portion of a different one of said cells.

7. The medication container of claim 6, wherein
the cells are substantially identical, and
the apertures are substantially identical.

8. The medication container of claim 5, wherein
the body includes a perimeter,
the conductor sheet includes a perimeter, and
the perimeter of the conductor sheet substantially coincides with the perimeter of the body.

9. The medication container of claim 5, wherein the body is substantially comprised of a non-conductive material.

10. The medication container of claim 9, further comprising a cover secured to the upper surface of the body and substantially comprised of a frangible, conductive material.

11. The medication container of claim 5, configured as a blister pack.

12. A method of manufacturing a medication container, comprising
providing a conductive material defining a slot and at least one aperture;
electrically coupling an RFID chip to the conductive material, thereby forming a wireless communication device;
providing a thermoformable material including an upper surface and a lower surface;
securing the conductive material to the lower surface of the thermoformable material; and
forming at least one cell in the thermoformable material so as to cause at least a portion of the at least one cell to be received by the at least one aperture of the conductive material.

13. The method of claim 12, wherein
said providing a conductive material includes providing a substantially planar conductive material, and
said providing a thermoformable material includes providing a substantially planar thermoformable material.

14. The method of claim 12, wherein said securing the conductive material to the lower surface of the thermoformable material includes forming a laminate of said conductive material and said thermoformable material.

15. The method of claim 12, wherein said forming at least one cell in the thermoformable material includes forming said at least one cell by vacuum-forming.

16. The method of claim 12, wherein said forming at least one cell in the thermoformable material includes forming said at least one cell by pressing a heated tool into the thermoformable material.

17. The method of claim 12, further comprising
inserting a medication into the at least one cell, and
securing a cover material to the upper surface of the thermoformable material, thereby enclosing the medication within the at least one cell.

18. The method of claim 17, further comprising configuring the medication container as a blister pack.

19. The method of claim 12, wherein
said providing a conductive material including providing a conductive material defining a plurality of apertures, and
said forming at least one cell in the thermoformable material includes forming a plurality of cells in the thermoformable material so as to cause at least a portion of each cell to be received by a different one of said apertures of the conductive material.

20. The method of claim 19, wherein said forming at least one cell in the thermoformable material includes simultaneously forming said plurality of cells in the thermoformable material.
